(19) United States
(12) Patent Application Publication
(10) Pub. No.: US 2022/0297129 A1
(43) Pub. Date: Sep. 22, 2022

(54) DIGITAL MICROFLUIDICS DEVICES AND METHODS OF USE THEREOF

(71) Applicant: MIROCULUS INC., San Francisco, CA (US)

(72) Inventors: Jorge Abraham SOTO-MORENO, San Francisco, CA (US); Gregory Arthur RAY, San Francisco, CA (US); Foteini CHRISTODOULOU, San Francisco, CA (US)

(73) Assignee: MIROCULUS INC., San Francisco, CA (US)

(21) Appl. No.: 17/630,048

(22) PCT Filed: Jul. 27, 2020
(86) PCT No.: PCT/US2020/043675

§ 371 Date: Jan. 25, 2022

Related U.S. Application Data
(60) Provisional application No. 62/878,689, filed on Jul. 25, 2019.

(51) Int. Cl. B01L 3/00

(52) U.S. Cl. CPC B01L 3/502792; B01L 2200/147; B01L 2300/1861; B01L 2400/0427; B01L 2200/04; B01L 2300/1894; B01L 2300/168

(57) ABSTRACT

Digital microfluidic (DMF) apparatuses and methods for optically-induced heating and manipulating droplets are described herein. DMF apparatuses employing photonic heating as described herein provide radical simplification of routing droplets/reagents in complex, multistep protocols and/or highly plexed workflows.

### CROSS REFERENCE TO RELATED APPLICATIONS

This patent application claims priority to U.S. provisional patent application No. 62/878,689, titled “OPTICAL HEATING AND CONTROL FOR DIGITAL MICROFLUIDICS,” and filed on Jul. 25, 2019, herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### FIELD

Digital microfluidic (DMF) apparatuses and methods for optically-induced heating and manipulating droplets are described herein.

### BACKGROUND

Microfluidics has transformed the way traditional procedures in molecular biology, medical diagnostics, and drug discovery are performed. Lab-on-a-chip and biochip type devices have drawn much interest in both scientific research applications as well as potentially for point-of-care applications because they carry out highly repetitive reaction steps within a small reaction volume, saving both materials and time. Traditional biochip-type devices utilize micro- or nano-sized channels and typically require corresponding micropumps, microvalves, and microchannels coupled to the biochip to manipulate the reaction steps. As a result, these additional components greatly increase cost and complexity of biochip-type microfluidic devices.

Digital microfluidics (DMF) has emerged as a powerful preparative technique for a broad range of biological and chemical applications. DMF enables real-time, precise, and highly flexible control over multiple samples and reagents, including solids, liquids, and even harsh chemicals, without need for pumps, valves, or complex arrays of tubing. In DMF, discrete droplets of nanoliter to microliter volumes are dispensed from onto a planar surface where they are manipulated (transported, split, merged, mixed, heated, cooled) by applying a series of electrical potentials to an embedded array of electrodes. Straightforward control over multiple reagents, without requiring pumps, valves or tubing, is provided. Facile handling or both solids and liquids is possible, and is not subject to channel clogging. Even troublesome reagents such as organic solvents or corrosive chemicals may be handled upon the droplet handling surface as DMF systems generally have a hydrophobic surface which is substantially chemically inert (such as, but not limited to Polytetrafluoroethylene (PTFE)-coated surfaces). Complex reaction steps can be carried out using DMF alone, or using hybrid systems in which DMF is integrated with channel-based microfluidics.

Despite significant advances, currently available architectures for a DMF apparatus (e.g., system, device, etc.) typically employ thermoelectric cooling (TEC) heater devices at fixed positions underlying a droplet actuation surface of a DMF apparatus (e.g., affixed to the lower surface of a PCB substrate having actuation electrodes adjacent to the upper surface thereof). This can be limiting when designing DMF apparatuses to support complex multistep protocols or multiplex operations.

There is a need to develop more flexible DMF apparatuses affording “on demand” heating across the droplet manipulation surface of the DMF apparatus to enable these more demanding workflows.

### SUMMARY OF THE DISCLOSURE

The present invention relates to digital microfluidics (DMF) apparatuses (e.g., systems, devices, etc.) that utilize photonic heating (i.e., light absorption by certain materials, converting the energy from illumination into thermal energy) to heat droplets disposed on or adjacent to a droplet manipulation surface of a support (e.g., an upper surface of a PCB) of the DMF apparatus. Generally, the apparatuses described herein direct illumination at the opposite side of the support (e.g., the lower surface of the support), away from the droplet manipulation surface, heating the region of illumination of the lower surface of the support and transferring thermal energy to the upper surface of the support without directly illuminating the droplet, which may prevent photonic damage to the material being transported by the droplet. The transferred thermal energy heats a region about the upper surface of the support (in some variations the associated drive electrode), resulting in heating the droplet. Illumination of the droplet itself is avoided, thereby preventing exposure and possible degradation of reagents or samples contained within the droplet.

The amount of thermal energy produced at the lower surface of the support may be detectable as a characteristic black-body radiation of the material disposed at the illuminated location, and the detected temperature can be used within a closed loop feedback system to modulate the heating of the droplet. Alternatively or additionally, the temperature may be detected by one or more thermistors or other temperature sensors in/on the first support, (e.g., electrowetting drive electrodes, light absorbing regions, thermally conductive vias, etc.). The selective and independent illumination of one or more locations of the lower surface of the support permits multiplexed heating at highly flexible positions upon the droplet manipulation surface of the support.

Any of the apparatuses described herein may also provide cooling, an in particular cooling from within the region between the upper (first) support and the lower (second) support. For example, cooling of the droplet manipulation surface can also be achieved, permitting complex heating/cooling operations at a myriad of positions upon the droplet manipulation surface of the DMF apparatus.

A significant advantage of a DMF apparatus employing photonic heating as described herein is the radical simplification of routing droplets/reagents in complex, multistep protocols and/or highly plexed workflows. The workflow controller has much greater freedom in pathfinder algorithm operations to focus solely on reagent/droplet cross-contamination rules without having to consider such hardware limitations as fixed positions of hardware-driven heating components such as TEC heaters attached to the lower surface of the droplet manipulation support. A DMF apparatus employing an architecture coupling two supports, e.g., PCBs, which are connected or coupled together to provide droplet manipulation and droplet heating/cooling as described herein can also provide reduced cost by removing typically used TEC heating/cooling devices. A DMF apparatus so configured may also provide greatly improved power efficiency compared to a DMF apparatus incorporating a plurality of TEC heating/cooling devices to provide similar numbers of heating/cooling regions.

For example, described herein are digital microfluidic (DMF) apparatus that may include: a seating region configured to seat a DMF cartridge thereon; a plurality of electrowetting drive electrodes in electrical communication with the seating region; a plurality light-absorbing regions thermally coupled to a plurality of regions of the seating region; a plurality of light emitters separated from the seating region by a first air gap, wherein each light emitter is configured to emit light into the air gap to heat one or more of the light-absorbing regions; and a controller configured to control the light emitted by each of the light emitters to regulate a temperature of each of a plurality of regions within a second air gap of the DMF cartridge seated in the seating region.

Any of these apparatuses may include a plurality of thermally conductive vias coupling the plurality of light-absorbing regions to the plurality of regions of the seating region. These apparatuses may also include a plurality of thermal sensors configured to provide thermal data to the controller.

For example, described herein are digital microfluidic (DMF) apparatuses, and particularly air-gap DMF apparatuses (although not limited to air-gap DMF apparatuses) that include photonic heating. In some variations a DMF apparatus may be configured to provide photonic heating without illuminating the droplet being manipulated. A DMF apparatus may include: a first support having an upper surface and a lower surface; wherein the upper surface comprises a plurality of electrowetting drive electrodes; wherein the lower surface comprises a plurality light-absorbing regions; wherein each light absorbing region is thermally coupled to one or more regions of the upper surface by one or more thermally conductive vias; a plurality of light emitters disposed beneath the first support and separated from the first support by an air gap, wherein each light emitter of the plurality of light emitters are configured to emit light into the air gap to heat one or more light-absorbing regions; a plurality of thermal sensors; and a controller configured to receive input from each thermal sensor of the plurality of thermal sensors and to control the light emitted by one or more of the plurality of light emitters to regulate a temperature of one or more of the one or more regions of the upper surface.

The first support may be a printed circuit board (PCB) or other rigid or semi-rigid support. In some variations, drive electrodes (electrowetting drive electrodes) are embedded in, layered on and/or recessed flat or into the outer (upper) surface of the first support. In some variations the first support is configured as a seating surface onto which a cartridge may sit, placing a hydrophobic layer in electrical communication with the electrowetting drive electrodes, so that a droplet may be moved within an air gap formed in the cartridge, e.g., on top of a sheet of dielectric material of the cartridge. In some variations the plurality of electrowetting drive electrodes stand proud of the first support; alternatively the drive electrodes may be recessed and/or flush with the upper surface.

The lower surface on the back of the first support may include the plurality of light-absorbing regions. Each region maybe formed as a layer, coating, etc. on the lower surface. Alternatively or additionally each light-absorbing region may be integrally formed on or in the lower surface.

The thermally conductive vias may be configured to connect the light-absorbing region(s) on the second, e.g., back, surface of the first support with a region of or in the upper surface. These regions may be thermal control regions and may include, encompass or be defined by the one or more drive electrodes. For example, in some variations the thermally conductive vias may connect to one or more drive electrodes.

The plurality of light emitters may be positioned within an inner air gap behind the drive electrodes and the first support. In some variations this second region may be closed off (e.g., sealed, enclosed, etc.) from the rest of the apparatus, and particularly the upper or outer surface of the first support. This inner air gap region may not be configured to drive a droplet within via electrowetting.

The controller may be part of any of the DMF systems described herein. The controller may be a photonic heating controller or it may be a controlled configured and intended to control the DMF in addition to the photonic heating of one or more regions. In some variations the controller may separately address any of the individual heating regions (e.g., regions of or adjacent to the upper surface. As mentioned, the photonic heating may be applied with feedback from one or more thermal sensors that may form part of a control loop to regulate the temperature with precision (e.g., +1-1 degree, 0.7 degrees, 0.5 degrees, 0.2 degrees, etc. or less). Multiple regions may be controlled in parallel and/or sequentially. The multiple regions may be all of the regions or subsets of the regions. Regions may be separate or may be coupled together.

For example, each thermal sensor of the plurality of thermal sensors may be configured to detect a temperature of one or more of the light-absorbing regions, thermally conductive vias or the upper surface. Each thermal sensor of the plurality of thermal sensors may be paired with a light emitter of the plurality of light emitters. All or some of the thermal sensor of the plurality thermal sensors may comprise a blackbody detector, thermistor, etc.

Any appropriate light emitter may be used. For example, the light emitter of the plurality of light emitters may include one or more of: one or more (e.g., a plurality of) LEDs or optical fibers. The plurality of light emitters may each configured to emit light having a wavelength at least in part from 800 nm to 1000 nm.

Any of the apparatuses described herein may also include one or more (e.g., an array of) optical components such as lenses, optical fibers, etc. to focus, aim, limit, filter, etc. light from one or more of the plurality of light-absorbing elements. For example, any of these apparatuses may include a focalizer on some or all of the light emitters that is/are configured to direct each of the plurality of light emitters to selectively illuminate at least one of the light absorbing regions of the plurality of light absorbing regions.

Each of the light-absorbing regions of the plurality of light absorbing regions may be configured to convert absorbed light energy to thermal energy. For example, each of the thermally conductive vias may be configured to thermally couple one of the light absorbing regions of the plurality of light absorbing regions with one or more of the actuation electrodes of the plurality of actuation electrodes.

Any of the apparatuses described herein may include a plurality of light-absorbing regions and subsequent thermal control regions. For example, any of the apparatuses described herein may comprise 10 or more regions (e.g., 15 or more regions, 20 or more regions, 30 or more regions, 40 or more regions, 50 or more regions, 60 or more regions, etc.) of the upper surface that are thermally regulated. For example, the controller may be configured to selectively control each of these thermal control regions (e.g., each of the 10 or more, 15 or more 20 or more, 30 or more, 40 or more, 50 or more, 60 or more, etc., regions of the upper surface).

Any appropriate light-absorbing region may be used. For example, the light-absorbing region may comprise a black soldermask or graphite heat-spreading material. The graphite may be configured as a heat-spreading material that may be disposed upon the second surface of the first support in selected regions around each of the plurality of thermal vias.

Similarly, the thermally conductive vias may be formed of any appropriate material. For example, a thermally conductive via may be formed of a thermally conductive metal or polymer.

As mentioned the or more supports may be a PCB.

The plurality of light emitters may be coupled to a second support extending parallel to the first support. The second support may comprises a PCB.

The controller may include a microprocessor. The controller (including the microprocessor) may be configured to adjust power applied to the light emitters based at least in part on feedback from the plurality of thermal sensors.

Any of these apparatuses may include a cooler within the temperature-regulating air-gap. For example, the cooler may be a cooling means. The cooler may include one or more fans configured to push cooling gas along the lower surface of the first support within the temperature-regulating air-gap; one or more negative pressure sources configured to draw cooling gas along the bottom surface of the first support; or a compressor configured to push cooling gas along the bottom surface of the first support. The cooler may include an electrostatic fluid generator configured to ionize particles in the temperature-regulating air-gap to enable air movement.

Any of these DMF apparatuses may include a droplet-manipulating region configured as a second air gap above the upper surface.

Any of these apparatuses may include or be configured to work with a removable/replaceable cartridge configured for droplet manipulation and disposed adjacent to the plurality of actuation electrodes disposed on the upper surface of the first support. The cartridge may include a lower dielectric material that is configured to be secured down onto the first support and the drive electrodes. The cartridge may include e a ground or return electrode. In some variations the cartridge does not include the drive electrodes, which may be on the separate DMF apparatus.

For example, a digital microfluidic (DMF) apparatus may include: a first support having an upper surface, a lower surface and a thickness therethrough, comprising a plurality of electrowetting drive electrodes disposed on the upper surface, a light-absorbing region disposed on the lower surface, and a plurality of thermally conductive vias disposed between the lower surface and the upper surface and passing through the thickness, the plurality of thermally conductive vias configured to heat a droplet disposed adjacent to the upper surface of the first support; a second support comprising an upper surface adjacent to the lower surface of the first support, wherein a plurality of light emitters and a plurality of thermal sensors are disposed on the upper surface of the second support, each of the plurality of light emitters configured to illuminate one or more locations of the light-absorbing region on the lower surface of the first support; wherein the first support and the second support are coupled together to form a temperature-regulating air-gap between the lower surface of the first support and the upper surface of the second support; and a droplet-manipulating air-gap adjacent to the upper surface of the first support. Each one of the plurality of light emitters may be paired with one of the plurality of thermal sensors, wherein each thermal detector of the plurality is configured to detect a temperature of the one or more locations on the lower surface of the first support illuminated by the respective paired light emitter of the plurality.

Also described herein are methods of operating any of the apparatuses described herein. For example, a method of heating a droplet within a digital microfluidic (DMF) apparatus may include: disposing a droplet adjacent to a location of an upper surface of a first support, wherein the upper surface comprises a thermally conductive via underlying the droplet, the thermally conductive via passing through a thickness of the first support adjacent to a lower surface of the first support; illuminating a selected location of the lower surface of the first support adjacent to the thermally conductive via, wherein the lower surface comprises a light-absorbing region configured to receive light energy; converting the light energy to thermal energy, thereby heating the thermally conductive via; and conducting the thermal energy through the thermally conductive via to the location of the upper surface of the first support, thereby heating the droplet.

The illuminating the selected location of the lower surface of the first support may include activating one or more light emitters disposed adjacent to an upper surface of a second support, the upper surface of the second support spaced apart from the lower surface of the first support by a temperature-regulating air-gap. Activating the one or more light emitters may include selectively activating at least one of the one or more light emitters to illuminate only the selected location of the lower surface of the first support. Activating each of the one or more light emitters may further comprise activating each of the one or more lights emitters to selectively illuminate one of more than one pre-selected regions of the lower surface of the first support, wherein each of the one or more light emitters is configured to illuminate the more than one pre-selected regions of the lower surface of the first support.

In some variations, heating the droplet further comprises controlling the heating to heat the droplet to a selected temperature. Controlling the heating may further comprise detecting the temperature of the selected location of the lower surface of the first support.

Detecting the temperature of the selected location of the lower surface of the first support may comprise detecting reflected heat from the selected location by a thermal detector disposed adjacent to the upper surface of the second support. Alternatively or additionally, detecting the temperature may include using a thermistor or other temperature sensor on or in the first support.

In some variations, controlling the heating further comprises activating or deactivating at least one of the one or more light emitters based at least in part upon feedback from the thermal detector. The thermal detector may be disposed adjacent to the at least one of the one or more light emitters (a thermal detector and thermal sensor may refer to the same apparatus or part of the same apparatus).

Any of these methods may also include turning off the at least one of the one or more light emitters when a selected temperature is detected. The controller may generally include controlling the light emitters by controlling the power (current, voltage, both current and voltage) to each, some or all of the light emitters of the plurality of light emitters. In some variations the light emitters may be controlled by adjusting the frequency of the applied energy and therefore the frequency of the applied current and/or voltage may be adjusted.

Heating the droplet may further comprise maintaining a selected elevated temperature for a selected period of time.

Any of these methods may also include cooling the droplet after a selected period of time of heating. Cooling the droplet may comprise introducing cooling gas across the lower surface of the first support, thereby disbursing heat from the droplet. Introducing cooling gas may include drawing or pushing gas across the lower surface of the first support. For example, cooling the droplet amy include ionizing particles within a gas in a temperature-regulating air-gap below the lower surface of the first support to accelerate movement of the gas within the temperature-regulating air-gap, thereby disbursing heat from the droplet. Any of these methods may also include disposing a plurality of droplets adjacent to a plurality of locations of the upper surface of the first support, wherein the upper surface comprises a plurality of thermally conductive vias underlying each of the plurality of droplets; and heating each of the plurality of droplets.

The method may also or alternatively include disposing a plurality of droplets adjacent to a plurality of locations of the upper surface of the first support, wherein the upper surface comprises a plurality of thermally conductive vias underlying each of the plurality of droplets; and heating a selected subset of the plurality of droplets.

Heating each of the plurality of droplets may include illuminating a plurality of locations on the lower surface of the first support, and heating the plurality of thermally conductive vias underlying the plurality of droplets. The heating may be performed simultaneously at each location of the plurality of locations. The plurality of thermally conductive vias may include any appropriate number (e.g., 10 or more, 15 or more, 20 or more, 30 or more, 40 or more, 50 or more, 50 or more, etc.) of thermally conductive vias. In some variations 96 or 384 thermally conducive vias may be used.

Illuminating the plurality of locations on the lower surface of the first support may include activating a plurality of light emitters disposed adjacent to an upper surface of a second support, the upper surface of the second support spaced apart from the lower surface of the first support by a temperature-regulating air-gap.

Any of the method described herein may also include cooling each of the plurality of droplets after a selected period of time of heating.

The method may also include performing a selected number of cycles of heating and cooling the plurality of droplets.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 is a graphical representation of a microfluidic apparatus according to some embodiments of the disclosure.

FIG. 2 is a photographic representation of a portion of a lower support including light emitters and black-body thermal sensors according to some embodiments of the disclosure.

FIG. 3 is a graphical representation of a method of cooling according to some embodiments of the disclosure.

FIG. 4 is a graphical representation of a method of cooling according to some embodiments of the disclosure.

FIG. 5 is another example of a portion of a DMF apparatus configured to apply photonic heating as described herein.

FIG. 6A schematically illustrates one example of an apparatus (e.g., a DMF apparatus) configured to include photonic heating as described herein.

FIGS. 6B-6C illustrate one example of a DMF apparatus configured to provide photonic heating as described herein.

FIG. 7 schematically illustrates one variations of a method as described herein.

### DETAILED DESCRIPTION

In general, described herein are digital microfluidic (DMF) apparatuses that include a plurality of DMF drive electrodes that further include one or more thermally controlled region that at photonically heated and may be actively or passively cooled; the photonic heating may be performed from within the device.

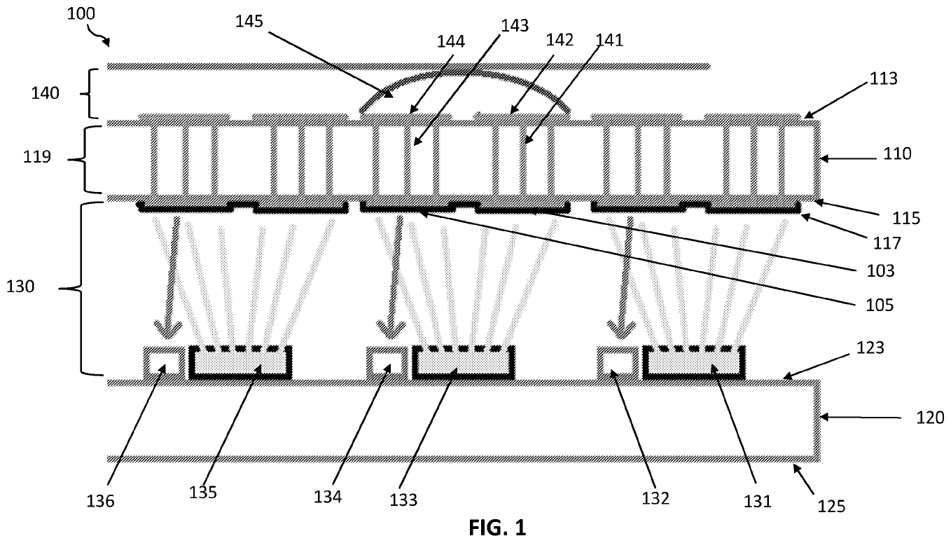

FIG. 1 shows an exemplary DMF apparatus 100, which has two supports, 110, 120, which may be PCBs, which function together to provide transport and heating/cooling to the droplet 145. Support 110, has an upper surface 113, and a lower surface 115, and a thickness therethrough 119. The upper surface 113 is the droplet manipulation surface 113, and faces the droplet-manipulating region 140. Droplet-manipulating region 140 may be oil-filled or it may be a droplet-manipulating air-gap (e.g., air-filled). In particular, the air-gaps described herein may be large air-gaps (e.g., greater than 280 micrometers, greater than 300 micrometers, >400 micrometers, >500 micrometers, >600 micrometers, or more. The droplet manipulation surface 113, in some variations, may interface with a disposable cartridge (not shown) disposed and secured upon the droplet manipulation surface 113. In any case, droplet 145 is disposed adjacent to the droplet manipulation surface 113 upon which a plurality of actuation electrodes 142, 144 is disposed. Thermally conducting vias 141, 143 have a first end adjacent to the lower surface 115, passing through the thickness 119 of the support 110, and have a second end adjacent to the surface 113, at an actuation electrode 142, 144 of support 110. There may be any number of thermally conducting vias, providing heating at any number of regions adjacent to the upper surface 113. There may be about 10, 25, 50, 75, 96, 100, 200, 300, 284 heating regions or more upon the surface 113. There is a layer of light-absorbing material 117 on the lower surface 115, which may be continuous (as shown) or which may be discontinuous, e.g., pads of light-absorbing material about and adjacent to the second end of the thermal vias 141, 143. The light-absorbing material may be any suitable material, including but not limited to black soldermask and graphite heat spreader material.

Illumination of regions 103, 105 of the light-absorbing region 117, transfer the thermal energy obtained from the illumination, to the thermally conductive vias 141, 143. The thermal energy is transferred from the first end of the thermally conductive vias 141, 143 to the second end of the vias adjacent to the actuation electrodes 142, 144 at the surface 113. The thermal energy is transferred to droplet 145 and heats it.

The apparatus includes a specific arrangement that permits illumination (light energy) to be provided selectively to location(s) on the light-absorbing region 117 of the lower (e.g., bottom) surface of the support 110. A second support 120, which may be a PCB, is disposed, having an upper surface 123, facing the lower surface 115 of the first support 110 with a temperature-regulating air-gap between. The temperature-regulating air-gap 130 may have a vertical dimension between surface 123 and surface 115 greater than 280 micrometers, greater than 300 micrometers, >400 micrometers, >500 micrometers, >600 micrometers, >700 micrometers, >800 micrometers, >1000 micrometers or more. In some variations, supports 110, 120 are coupled together to fix the temperature-regulating air-gap distance. Disposed upon the upper surface 123 of the second support 120 is a plurality of light-emitters 131, 133, 135. The light-emitters 131, 133, 135 may be LEDs, fiber optic fibers, or any suitable light-emitter. In some variations, the plurality of light-emitters may be generated from a single light source and split to emit light at the plurality of positions 131, 133, 135. The light-emitters may emit light in any desired wavelength range, e.g., from about 250 nm to about 100 nm. In some variations the light-emitters may emit light having a wavelength of about 800 nm to about 100 nm, or may emit light which, at least in part, emit light having a wavelength of about 800 nm to about 100 nm. In some variations, broad spectrum lights may be utilized, as generating a large amount of energy in one frequency can reduce efficiencies of transmission and absorption. The light-emitters 131, 133, 135 may be configured to illuminate one or more regions located on the light absorbing layer 117. For example, light-emitter 133 is configured to illuminate one or both of regions 103, 105 of the light-absorbing region 117, adjacent to thermally-conductive vias 141, 143. In some variations, the light-emitter 133 may include a pointing mechanism to direct the emitted light to one of several different locations. In some variations, the light-emitter 133 may be selectively activated to illuminate only one of regions 103, 105. Additionally, only one of light-emitters 131, 133, 135 may be selectively activated to emit light or any combination of light-emitters may be activated at the same time.

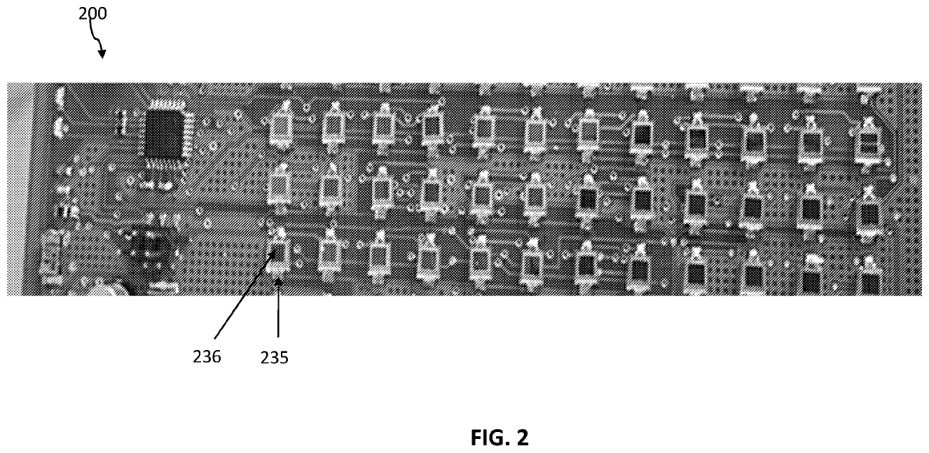

Thermal sensors 132, 134, 136 are disposed on the surface 123, and are disposed adjacent to each of a light-emitter 131, 133, 135 and may be paired to detect the thermal energy from the one or more regions illuminated by its respective paired light-emitter. For example, thermal detector 134 may detect the thermal energy, such as the black radiation in the infrared (non-visible) region of light, which can determine temperature from regions 103 and/or 105 of the light absorbing layer 117. Since the thermally conductive vias 14, 143 are conductive, the temperature of the droplet may be determined and controlled. The thermal sensors may be included in a closed-loop feedback system in order to control the temperature of the droplet 145. FIG. 2 shows an example of the upper surface 200 of a PCB having a plurality of light emitters (one instance is labeled at 235) and black body radiation thermal sensors (one instance is labeled at 236).

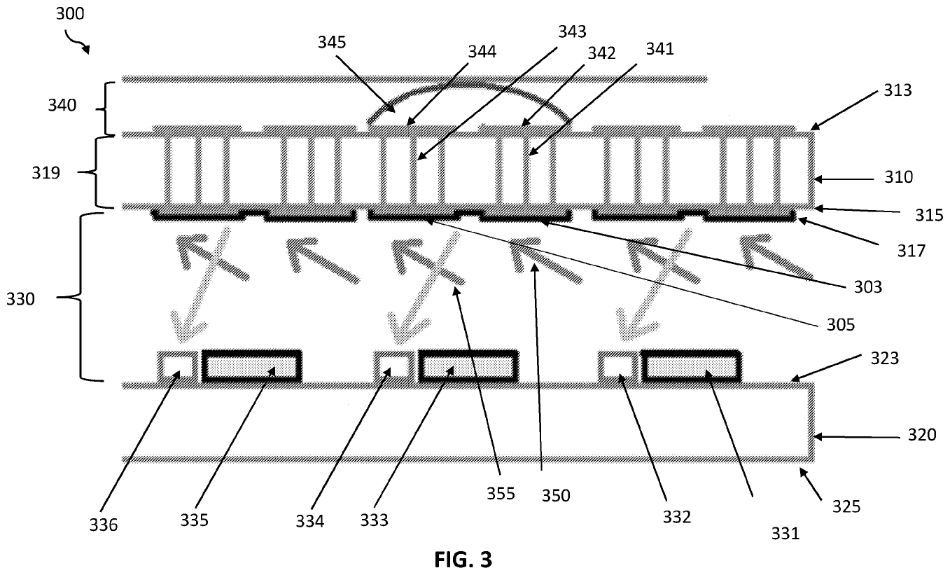

The DMF apparatus may further include components configured to cool the first support, e.g., the support having the droplet manipulation surface. Many protocols and workflows require a period of heating followed by a period of cooling, which may be repeated for any number of cycles. FIG. 3 shows the DMF apparatus 300, which is similar to apparatus 100 of FIG. 1 and may have any of the features described for apparatus 100. A droplet 345 is disposed within a droplet-manipulating air-gap above the droplet-manipulating surface (upper surface 313) of upper support 310, which may be a PCB. Actuation electrodes 342, 244, underlay the droplet 345, and thermally conducting vias 341, 343, pass through the thickness 319 of the support 310, adjacent to the lower (bottom) surface 315, and light- absorbing layer 317, and specifically adjacent to regions 303, 305 of the light-absorbing region 317. Once a desired period of heating has been completed, light-emitters 331, 333, 335 upon the upper surface 323 of the second support 320, disposed across the vertical dimension of the thermal-regulating region 330, are deactivated. Light energy is no longer delivered to the light-absorbing region 317 of the lower surface 315 of support 310, which is similar to support 110. The regions 303, 305 may cool by passive cooling, dissipating energy into the support 310. Cooling may be enhanced by pushing/drawing cooler gas/air across the underside of the support 310 (see flow arrows 350, 355). The pushing or drawing of the cooler gas may be performed by a compressor, a fan and may be coupled with a source of negative pressure to exchange cooling gas. This removes thermal energy and decreases the temperature of the support 310, thermal vias 341, 343, and the droplet 345. The change in thermal energy can be monitored by the thermal sensors 332, 334, 336. For example, thermal detector 334 can monitor the thermal energy at regions 303 and/or 305, which related to the temperature of the droplet 345, permitting determination of the temperature of the droplet 345. Once the temperature has dropped to a desired temperature an additional period of heating may be instituted by activating light-emitter 333 again.

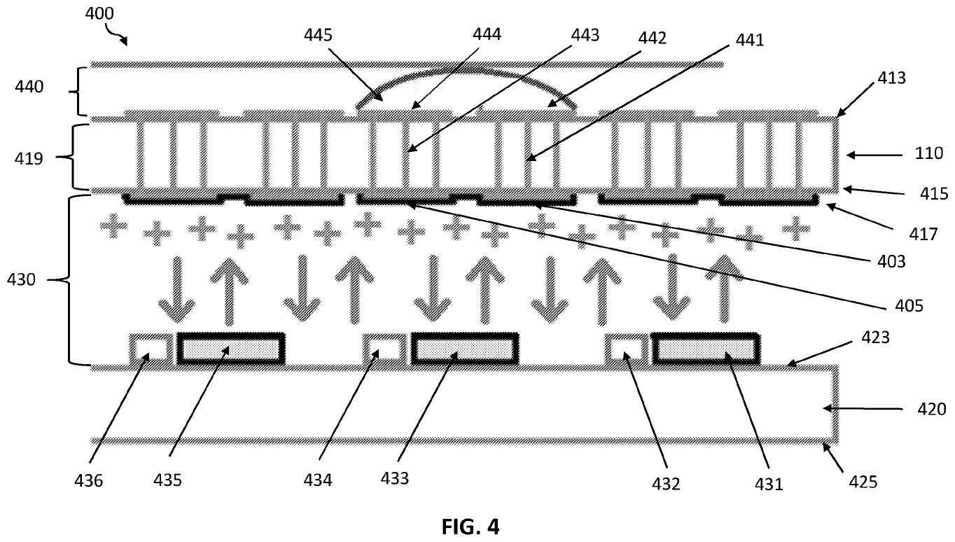

FIG. 4 shows a variation of the DMF apparatus of FIG. 3, where the cooler is configured as an electrostatic fluid generator configured to ionize particles in the temperature-regulating air-gap to enable air movement. The ionized particles move, moving the air and cooling the region to cool. Convection cooling and/or Peltier cooling may also or additionally be applied.

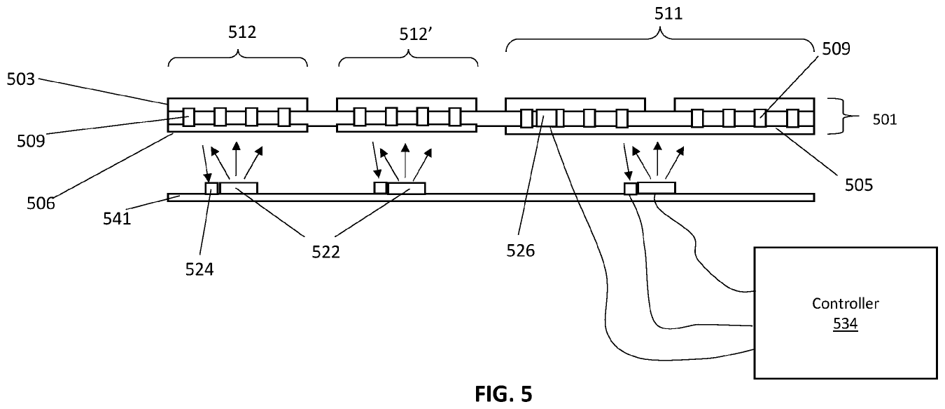

FIG. 5 illustrates another example of a portion of an apparatus as described herein including a first support 501. A plurality of drive electrodes 503 are formed on top of the first support. In FIG. 5, multiple drive electrodes may be placed in thermal communication with a single light-absorbing region 505 (e.g., so that the heat/cooling will conduct between these elements and they will rapidly have the same temperature). As used herein, a light-absorbing region refers to a region comprising a material that absorbs light and coverts it to heat, typically warming based on the photonic energy applied. In FIG. 5 a plurality of thermally-conductive vias 509 conduct thermal energy from the light-absorbing region to the external surface of the first support. In this example the thermal vias are in communication with the drive electrodes, which may be thermally conductive as well, and may heat or cool as the light-absorbing region heats and/or cools. In FIG. 5, at least one large thermally controlled region 511 includes two (or more, not shown) drive electrodes. This example also shows individual, smaller, thermally controlled regions 512, 512′ that are connected through the thickness of the first support via one or more vias 509 to a separate light-absorbing region 506. Each thermally controlled region may be illuminated by one or more light sources 522. The light sources may be configured to efficiently heat the light-absorbing material (e.g., so that the light is converted to heat with a high efficiency). Multiple light sources may be used to illuminate a single thermally controlled region (e.g., a single light-absorbing region). The light sources may be connected to a controller 534 that may individually and/or collectively regulate the temperature of each thermally controlled region by controlling the light source(s) and/or any coolers, as described in FIGS. 3-4, above. The controller may receive thermal (temperature) data for each thermally controlled region and/or a droplet above the thermally controlled region. For example one or more thermal sensors may be included per thermally-controlled region. A blackbody detector 524 may be included and/or a thermistor 526. These temperature sensors may provide feedback to the controller to regulate the temperature of the thermally controlled region and therefore any droplet that is adjacent to the thermally controlled region on the upper surface (even through a dielectric material placed over the upper surface, not shown). The controller may be part of the lower, second support 541 (e.g. PCB) as may the light sources and/or thermal sensors.

In general, the methods and apparatuses described herein are DMF apparatuses that may include photonic heating as part of the control system for controlling localized temperature control of one or more (preferably a plurality of) DMF regions, such as regions within an air gap in which one or more droplets may be moved the DMF apparatus. Any appropriate DMF apparatus may be configured and/or operated as described herein to include photonic hating. For example, the apparatuses (systems, devices, etc.) described in PCT/US2020/02025, filed on Feb. 28, 2020, and herein incorporated by reference in its entirety, may include photonic heating as described herein.

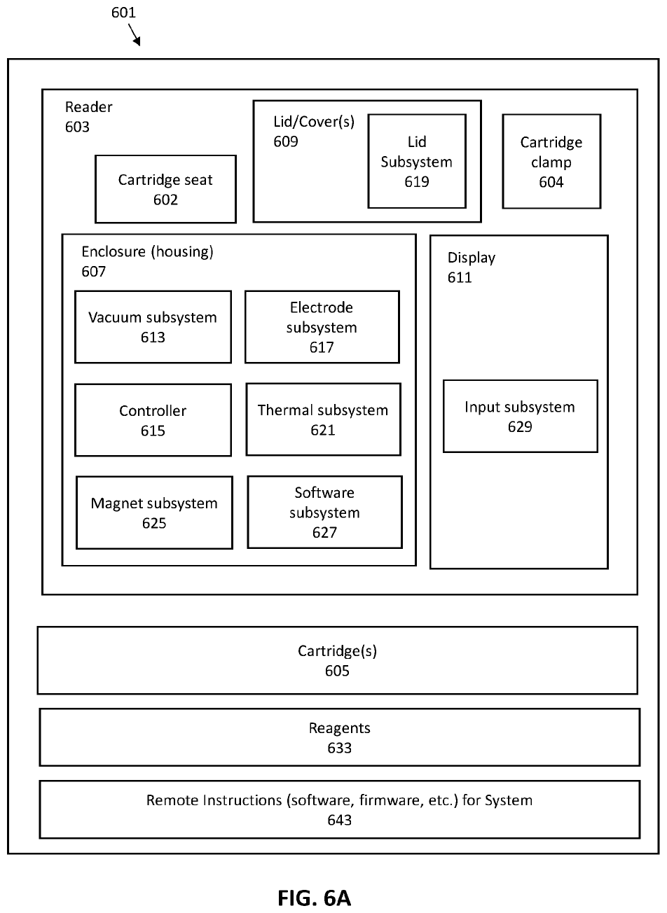

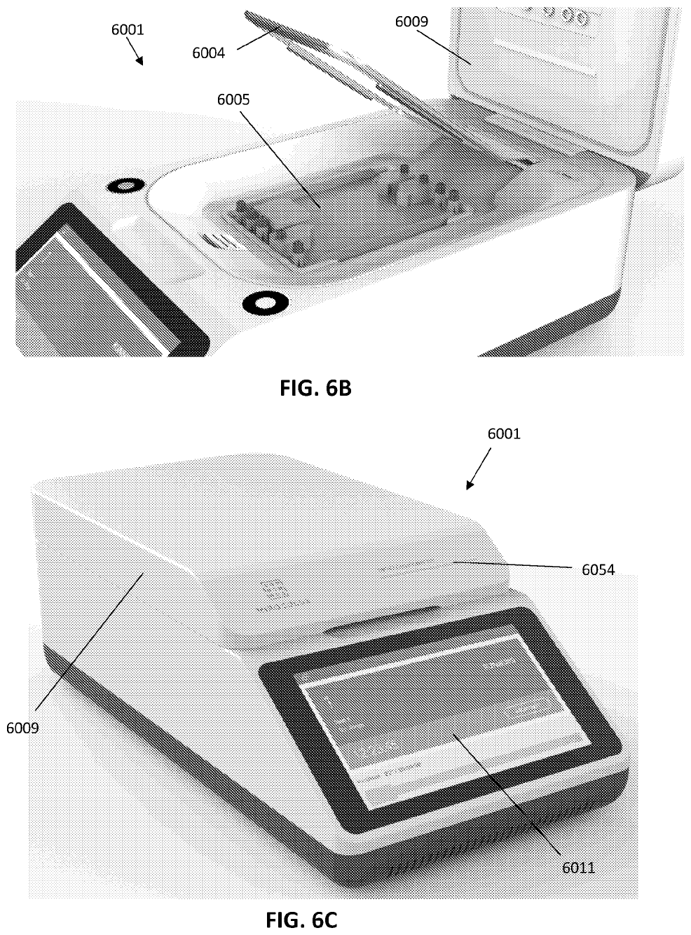

For example, FIG. 6A illustrates one example of a digital microfluidic (DMF) apparatus that may be configured to provide local/regional temperature control within a DMF reaction region (e.g., air gap). In FIG. 6A the apparatus (e.g., a system 601) include a DMF reader 603. The apparatus may be configured for use with or may include: one or more cartridges 605 and one or more reagents 633. The reader may include software, firmware or the like 643 that may be run remotely (e.g., desktop, laptop, mobile device, pad, etc.) for communication with, controlling, and/or creating, transmitting or modifying protocols and other operational parameters of the system (e.g., the DMF apparatus, or a reader 603). The reader may refer to the DMF apparatus that controls the application of energy (e.g., voltage) to drive droplets for processing the droplets, including controlling the temperature and/or magnetic field. In this example, the reader 603 is adapted to receive the cartridge(s) into a seat 602 and secure the cartridge, e.g., using one or more keyed regions and/or a vacuum to both orienting and secure the cartridge in the seating region. The reader may include a lid or cover 609 that may include and/or enclose a lid subsystem 619. The reader may also include a cartridge clamp 604 that may act as a safety lock or interlock when a cartridge is held within the cartridge seat. The cartridge clamp may be part of the lid or lid system, or it may be separate. The reader in FIG. 6A may also include a housing or enclosure 607 that may fully or partially cover a controller 615 (including one or more processors, circuitry, clock, power regulators, wireless communication circuitry, memory, etc.), and the one or more subsystems controlling operation of the DMF and microfluidics on the cartridge. The controller may include a microcontroller, input interface (e.g., touchscreen, button, knob, etc.) circuitry, output interface (e.g., Ethernet, WiFi, etc.), etc. The reader may also include, e.g. within the housing, a vacuum sub-system 613, an electrode sub-system 617, a thermal control sub-system 621, a magnet control sub-system 625 and/or a software sub-system 627; any or all of these sub-systems may communicate and/or be coordinated by the controller.

For example, the vacuum sub-system may include a vacuum chuck, a vacuum pump, and one or more pressure sensors for detecting (and/or providing feedback to control the vacuum) pressure. The software subsystem may include software, hardware or firmware, such as a non-transitory computer-readable storage medium storing a set of instructions capable of being executed by the one or more processors of the controller to coordinate operation of the systems, including any of the sub-systems. The thermal subsystem may include the TECs, heat sinks/fans, and one or more thermal sensors (including thermal sensors configured to monitor temperature of the cartridge, e.g., the air gap region and/or one or more thermal sensors configured to monitor the temperature of/within the housing, of the TECs, etc.). The magnetic subsystem may include, for example, one or more magnets (such as one or more Halbach array magnets), one or more actuators for all or some of the magnets and one or more position sensors for monitoring/detecting the positon of a magnet (e.g., a home sensor).

The housing may be connected to, and/or may partially enclose one or more inputs and/or outputs 611, such as a display and input subsystem 629. The display may be a touchscreen and/or one or more buttons, dials, etc.

An electrode sub-system may include the array of drive electrodes (e.g. an electrode array) underlying the cartridge seat, one or more high-voltage drivers, one or more TEC driver, a safety interlock, one or more resistive heaters, etc.

The lid may couple to the housing and may at least partially enclose the lid subsystem, as mentioned above. The lid sub-system may include, for example, one or more pipette pumps, a vacuum manifold, one or more solenoid valves, one or more pressure sensors, one or more positional sensors, and one or more indicators (e.g., LEDs, etc.). The lid may be hinged to close over the cartridge and against the housing; this lid (and the cartridge clamp) may, separately, lock over the cartridge when it is loaded into the reader, and may be hinged to the housing. As mentioned, the cartridge clamp may be coupled to the housing and may be covered by the lid.

As descried herein the apparatus (e.g., the “reader”) may include a thermal subsystem 621 that may include a plurality light-absorbing regions thermally coupled to a plurality of regions of the seating region (cartridge set 602) and a plurality of light emitters separated from the seating region by an internal air gap. Each light emitter may be configured to emit light into the air gap to heat one or more of the light-absorbing regions.

FIGS. 6B and 6C illustrate one example of DMF apparatus (or reader) that may be configured to include photonic heating as described herein. In FIG. 6B, the DMF apparatus 601 is shown with the lid open (FIG. 6C shows the same apparatus with the lid down). In FIG. 6B, the reader 6001 may include any of the features described herein, including the thermal subsystem features such as the light-absorbing region(s) on the underside of the seating region for holding a removable cartridge 6005. In FIG. 6B, showing the apparatus with the lid 6009 open, but the clamp 6004 latched closed, a cartridge 6005 is held within the seating region of the housing of the reader. In this state the high-voltage power to the drive electrodes may be ‘on’ and droplets may be moved or held in position using the drive electrodes (e.g., via electrowetting). This may prevent undesired movement of droplets or fluid in the cartridge when loading/unloading fluid. Safety interlocks may mitigate the risk of electrical shocks to a user applying liquid to the cartridge. For example, the clamp may cover the edges of the cartridge, so that only the upper surface (electrically isolated from the high-voltage drive electrodes) is exposed. The clamp latch may detect engagement and locking of the latch; the system may be configured to prevent voltage until and unless the clamp is latched. Other safety interlocks may also or alternatively be used. In this example the clamp latch is disengaged, and the clamp is shown raised to allow removal of the cartridge. Removal of the cartridge exposed the drive electrodes and thermally conductive regions connected by one or more vias (thermally conductive vias) to the light absorbing regions.

In FIG. 6C, the reader device 6001 is shown in with the lid 6009 closed, and locked, and the high-voltage engaged, as shown by the indicator 6054 on the lid. A cartridge has been inserted, and the touchscreen 6011 on the front of the device indicates the status of the reader and cartridge.

Although the example apparatus shown in FIGS. 6A-6C is configured for use with a removable cartridge holding an air gap within which the droplet(s) may be moved, any of the apparatuses described herein may instead by configured with an integrated air gap and/or for use with an oil gap within which the droplet is moved by DMF.

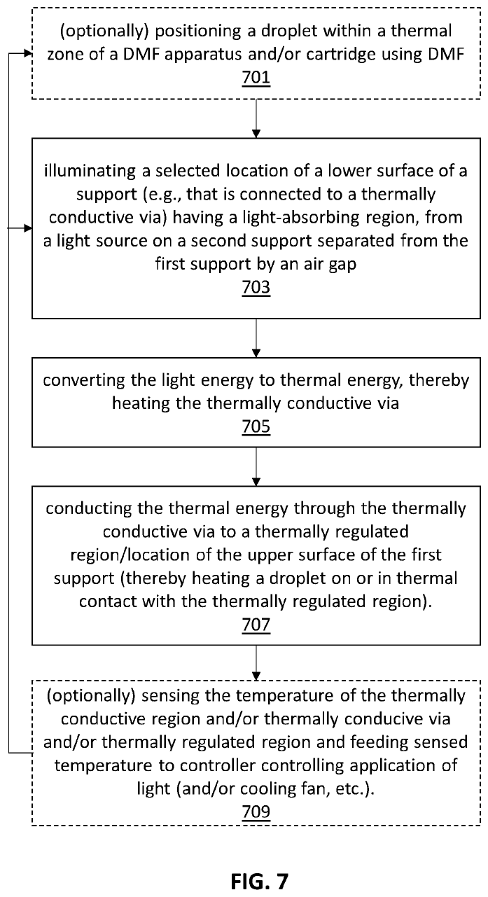

In operation, any of the apparatuses described herein may be used to process a droplet, or multiple droplets either in parallel (e.g., at the same time) and/or sequentially. For example, FIG. 7 illustrates one example of a method of controlling the temperature of sub-regions of a DMF apparatus using photonic thermal zones that can heat (enabling isothermal incubations) and cool fast. This method may be a method of heating a droplet within a digital microfluidic (DMF) apparatus, and/or a method of processing a droplet using DMF. Initially, one or more droplets may be positioned with a thermal control zone (or optionally, multiple droplets within multiple thermal control zones) 701. Alternatively or additionally, the temperature of the thermal control zone may be regulated before a droplet is positioned within the thermal control zone. For example, a droplet may be positioned adjacent to (e.g., on top of) a thermal control region/location of an upper surface of the DMF apparatus. The upper surface may be part of a seating region for holding a DMF cartridge within which the droplet is moved. The upper surface may include a thermally conductive via underlying the thermally controlled region (and in some variations, underlying the droplet). The thermally conductive via may conduct heat from the underside of the first support adjacent to the seating region. This region may be limited to a sub-region of the seating region (and therefore a sub-region of the cartridge).

The method may include illuminating a selected location of the lower surface of the first support. This selected location may include a light-absorbing region configured to receive light energy. The region may be illuminated by any appropriate light source, across an air gap region 703. The light emitted may be absorbed by the light-absorbing material and converted into heat 705. Examples of light-absorbing materials are provided herein, and may be coordinated with the applied wavelength, so that light is absorbed in a specific wavelength or range of wavelengths. In some variations different regions may include different light-absorbing materials that may absorb at different wavelengths. The light sources may then be controlled to emit specific wavelengths to heat select regions that match the emitted wavelength(s).

The heat generated by absorbing the light energy may then be transmitted through the support to the upper side by one or more thermally conductive vias. For example, the heat may be transmitted by a thermal via to a location on the upper surface of the support 707, thereby heating a droplet in thermal contact with this region/portion of the upper surface.

In some variations the droplet may be moved into a heated region. Alternatively or additionally, a droplet may be moved from the heated region to a second region that is not heated or a second region that is heated to a different temperature.

These methods may also include cooling one or more regions. For example, the air gap region between the support and a second support holding the light sources may be cooled (e.g., by a fan, etc.) as described above.

Any of the steps of these methods may also include monitoring the temperature of one or more of: the thermally conductive region, the thermally conductive via, and/or the thermally regulated region 709. The sensed temperature may then be provided as feedback to the controller that may adjust one or more of: the applied light, (turning it on/off or increasing/decrease the amount of light emitted), and/or cooling (e.g., a fan, negative pressure source, compressor, etc.). Thus the controller may regulate the temperature of the one or more regions.

Any of the apparatuses described herein may include an array of heaters and thermal sensors throughout the underside of the PCB (see, e.g., FIG. 2) and may offer the possibility to actuate some or all of them at once (enabling simultaneous parallel heating of multiple zones on DMF) or on demand, in select combinations or even one at a time in a sequential fashion. These photonic thermal zones can heat (enabling isothermal incubations) and cool fast, enabling regular thermocycling and even ultra-fast PCR.

The availability of “on demand” heaters across the surface of the DMF PCB as described herein may radically simplify the routing of droplets/reagents in complex, multistep protocols or high-plex operations. More specifically, these methods and apparatuses may give the path finding algorithm, which may schedule and determine which components get manufactured most broadly freedom to route reagents focusing solely on reagent cross-contamination rules without having to consider HW limitations such as a fixed positions of TEC heaters under the DMF PCB. With this flexibility the DMF cartridge can offer an on-demand a large number of independently controlled thermally-regulated regions (e.g., each corresponding to, e.g., 96 or 384 reaction well plate equivalent (for plexing reactions) or host complex, multi-step workflows such as: cell culture followed by either transfection/transformation or cell→cell based assay→cell isolation→cell lysis→library preparation for NGS or target molecule detection end point reactions (such as RT-qPCR or qPCR).

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A digital microfluidic (DMF) apparatus, comprising:
a seating region configured to seat a DMF cartridge thereon;
a plurality of electrowetting drive electrodes in electrical communication with the seating region;
a plurality light-absorbing regions thermally coupled to a plurality of regions of the seating region;
a plurality of light emitters separated from the seating region by a first air gap, wherein each light emitter is configured to emit light into the air gap to heat one or more of the light-absorbing regions; and
a controller configured to control the light emitted by each of the light emitters to regulate a temperature of each of a plurality of regions within a second air gap of the DMF cartridge seated in the seating region.

2. (canceled)

3. The apparatus of claim 1, further comprising a plurality of thermally conductive vias coupling the plurality of light-absorbing regions to the plurality of regions of the seating region.

4. The apparatus of claim 1, further comprising a plurality of thermal sensors configured to provide thermal data to the controller.

5. The apparatus of claim 1, wherein each thermal sensor of the plurality of thermal sensors are configured to detect a temperature of one or more of the light-absorbing regions, thermally conductive vias or the upper surface.

6. The apparatus of claim 1, wherein each thermal sensor of the plurality of thermal sensors is paired with a light emitter of the plurality of light emitters.

7. The apparatus of claim 1, wherein each light emitter of the plurality of light emitters comprises one or more of: one or more LEDs or optical fibers.

8. The apparatus of claim 1, wherein the plurality of light emitters are each configured to emit light having a wavelength at least in part from 800 nm to 1000 nm

9. The apparatus of claim 1, further comprising a focalizer configured to direct each of the plurality of light emitters to selectively illuminate at least one of the light absorbing regions of the plurality of light absorbing regions.

10. The apparatus of claim 1, wherein each of the light-absorbing regions of the plurality of light absorbing regions is configured to convert absorbed light energy to thermal energy.

11. The apparatus of claim 1, wherein each of the thermally conductive vias is configured to thermally couple one of the light absorbing regions of the plurality of light absorbing regions with one or more of the actuation electrodes of the plurality of actuation electrodes.

12. (canceled)

13. The apparatus of claim 1, wherein the light-absorbing region comprises black soldermask or graphite heat-spreading material.

14. The apparatus of claim 13, wherein the light-absorbing region is disposed in selected regions around each of the plurality of thermal vias.

15. The apparatus of claim 1, wherein the one or more thermally conductive vias each comprise thermally conductive metal or polymer.

16. (canceled)

17. The apparatus of claim 2, wherein the controller comprises a microprocessor configured to adjust power applied to the light emitters based at least in part on feedback from the plurality of thermal sensors.

18. The apparatus of claim 1, further comprising a cooler within the temperature-regulating air-gap.

19. The apparatus of claim 18, wherein the cooler comprises: one or more fans configured to push cooling gas along the lower surface of the first support within the temperature-regulating air-gap; one or more negative pressure sources configured to draw cooling gas along the bottom surface of the first support; or a compressor configured to push cooling gas along the bottom surface of the first support.

20. The apparatus of claim 18, wherein the cooler comprises an electrostatic fluid generator configured to ionize particles in the temperature-regulating air-gap to enable air movement.

21. (canceled)

22. (canceled)

23. A digital microfluidic (DMF) apparatus, comprising:
a first support having an upper surface, a lower surface and a thickness therethrough, comprising a plurality of electrowetting drive electrodes disposed on the upper surface, a light-absorbing material disposed on the lower surface, and a plurality of thermally conductive vias disposed between the lower surface and the upper surface and passing through the thickness, the plurality of thermally conductive vias configured to heat a droplet disposed adjacent to the upper surface of the first support;
a plurality of light emitters and a plurality of thermal sensors disposed on a second support that is adjacent to the lower surface of the first support, wherein each of the plurality of light emitters is configured to illuminate one or more locations of the light-absorbing material on the lower surface of the first support; and
wherein the first support and the second support are separated by a temperature-regulating air-gap between the lower surface of the first support and an upper surface of the second support.

24. The apparatus of claim 23, wherein at least a portion of the upper surface of the first support is configured as a seating region configured to removably seat a DMF cartridge.

25. The apparatus of claim 23, further comprising a second air gap configured to hold the droplet adjacent to the upper surface of the first support.

26. The apparatus of claim 23, wherein each one of the plurality of light emitters is paired with one of the plurality of thermal sensors, wherein each thermal detector of the plurality is configured to detect a temperature of the one or more locations on the lower surface of the first support illuminated by the respective paired light emitter of the plurality.

27-50. (canceled)

51. A digital microfluidic (DMF) apparatus, comprising:
a first support having an upper surface and a lower surface;
wherein the upper surface comprises a plurality of electrowetting drive electrodes;
wherein the lower surface comprises a plurality light-absorbing regions;
wherein each light absorbing region is thermally coupled to one or more regions of the upper surface by one or more thermally conductive vias;
a plurality of light emitters disposed beneath the first support and separated from the first support by an air gap, wherein each light emitter of the plurality of light emitters are configured to emit light into the air gap to heat one or more light-absorbing regions;
a plurality of thermal sensors; and
a controller configured to receive input from each thermal sensor of the plurality of thermal sensors and to control the light emitted by one or more of the plurality of light emitters to regulate a temperature of one or more of the one or more regions
